(19) United States
(12) Patent Application Publication
(10) Pub. No.: US 2024/0246443 A1
(43) Pub. Date: Jul. 25, 2024

(54) SERVER DEVICE

(71) Applicant: TOYOTA JIDOSHA KABUSHIKI KAISHA, Toyota-shi (JP)

(72) Inventors: Takahiro AOKI, Saitama-shi (JP); Yuta TAKATA, Toyota-shi (JP); Haruki OGURI, Toyota-shi (JP); Takashi YAMAZAKI, Nagoya-shi (JP); Tsuyoshi OKADA, Nagoya-shi (JP); Hiroki ASAO, Tokyo (JP)

(73) Assignee: TOYOTA JIDOSHA KABUSHIKI KAISHA, Toyota-shi (JP)

(21) Appl. No.: 18/527,508

(22) Filed: Dec. 4, 2023

(30) Foreign Application Priority Data
Jan. 23, 2023 (JP) 2023-008355

(51) Int. Cl. B60L 53/66; G05D 1/226; G06Q 50/06

(52) U.S. Cl. CPC B60L 53/665; G05D 1/226; G06Q 50/06

(57) ABSTRACT

A server device includes a communication unit and a control unit. The control unit is configured to acquire information on a first power purchase price from a charging point and a second power purchase price from a facility, and when the second power purchase price is lower than the first power purchase price, send to a power supply vehicle configured to supply power to another vehicle an instruction to move along a travel route that passes through the facility.

### CROSS-REFERENCE TO RELATED APPLICATION

This application claims priority to Japanese Patent Application No. 2023-008355 filed on Jan. 23, 2023, incorporated herein by reference in its entirety.

### BACKGROUND

### 1. Technical Field

The present disclosure relates to server devices.

### 2. Description of Related Art

A battery electric vehicle (electric vehicle or EV) etc. driven by a battery may run out of power, that is, may run out of battery, while moving. Various techniques have been proposed to eliminate or avoid such a situation. For example, Japanese Unexamined Patent Application Publication No. 2019-093968 (JP 2019-093968 A) discloses a technique of charging a vehicle from another vehicle when the vehicle runs out of battery.

### SUMMARY

A power supply vehicle for supplying power to a vehicle that is out of battery needs to have a battery for power supply charged when supplying power, but there is room for improving the efficiency of charging the battery for power supply.

The present disclosure provides a server device etc. that can improve the charging efficiency of power supply vehicles.

A server device according to the present disclosure includes: a communication unit; and a control unit configured to communicate with a vehicle via the communication unit.

The control unit is configured to acquire information on a first power purchase price from a charging point and a second power purchase price from a facility, and when the second power purchase price is lower than the first power purchase price, send to a power supply vehicle configured to supply power to another vehicle an instruction to move along a travel route that passes through the facility.

According to the server device etc. of the present disclosure, it is possible to improve the charging efficiency of power supply vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of a vehicle management system; and

FIG. 2 is a diagram illustrating an operation procedure example of the server device.

### DETAILED DESCRIPTION OF EMBODIMENTS

Embodiments will be described below with reference to the drawings.

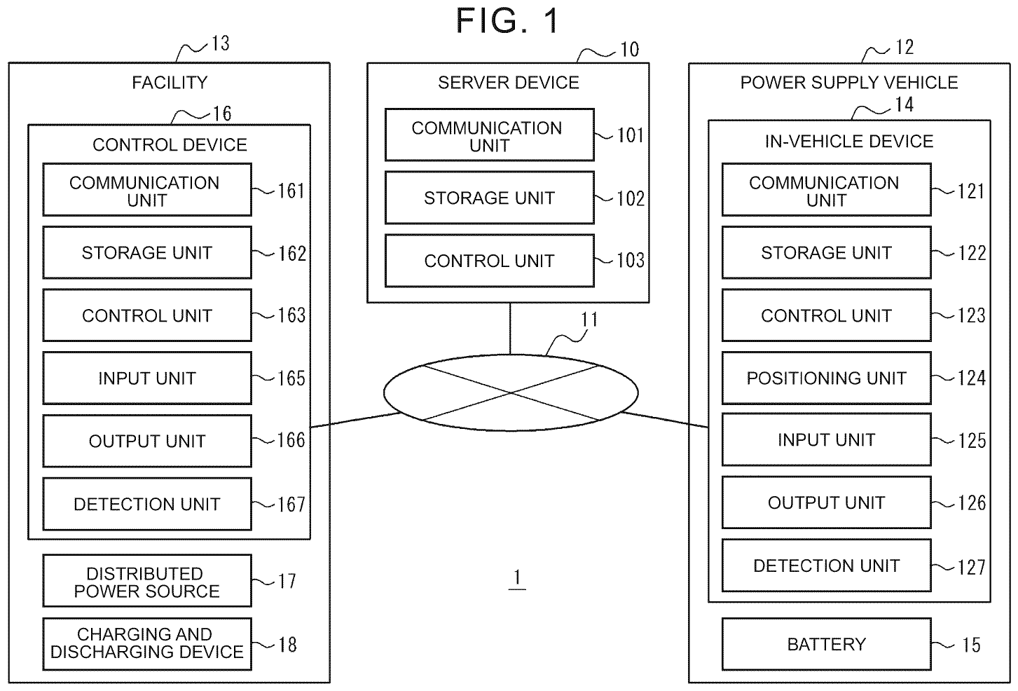

FIG. 1 is a diagram showing a configuration example of a vehicle management system according to one embodiment. The vehicle management system 1 has one or more server devices 10, power supply vehicles 12, and facilities 13, which are connected to each other via a network 11 so as to be able to communicate with each other.

The server device 10 is, for example, a server computer belonging to a cloud computing system or other computing systems and functioning as a server implemented with various functions. The power supply vehicle 12 is a passenger car or commercial vehicle having a communication function and an information processing function, and is connected to the network 11 via a mobile communication network. The power supply vehicle 12 is equipped with a battery 15 as a power source for supplying power to another vehicle that is out of battery. The power supply vehicle 12 is, for example, a gasoline vehicle, or a battery electric vehicle (BEV), a hybrid electric vehicle (HEV), a plug-in hybrid electric vehicle (PHEV), a fuel cell electric vehicle driven by electric power of an on-board battery 15, for example. (FCEV) and the like. The power supply vehicle 12 may be driven by a driver or may have any level of automated driving. The facility 13 is a residence, a commercial facility, or the like, which has a communication function and an information processing function, and is capable of covering power consumption by private power generation and selling surplus power to the power system. Network 11 may be, for example, the Internet, but may also include ad-hoc networks, LANs, Metropolitan Area Networks (MANs), or other networks or any combination thereof.

In the present embodiment, the vehicle management system 1 is a system for assisting in on-site charging of a vehicle such as a BEV, HEV, or PHEV that has run out of battery (hereinafter referred to as a vehicle with a dead battery) by the power supply vehicle 12. In the on-site charging, the power supply vehicle 12 moves to the position of a vehicle with a dead battery and charge the battery of this vehicle from the battery 15 of the power supply vehicle 12. Power supply is thus performed. In the vehicle management system 1, the server device 10 has a communication unit 101 and a control unit 103 that communicates with the communication unit 101. The control unit 103 acquires information on the power purchase price from a charging point and the power purchase price from the facility 13, and when the power purchase price from the facility 13 is lower than the power purchase price from the charging point, sends to the power supply vehicle 12 configured to charge a vehicle with a dead battery an instruction instructing the power supply vehicle 12 to move along a travel route that passes through the facility 13. Since the power supply vehicle 12 stops by the facility 13 before performing the on-site charging of the vehicle with a dead battery, it is possible to purchase a required charging amount from the facility 13 on the way to the on-site charging at a lower price than from a charging point such as a power supply station without stopping by the charging point. Therefore, it is possible to improve the charging efficiency of the power supply battery 15 of the power supply vehicle 12.

Next, a configuration example of the server device 10 will be described. The server device 10 has a communication unit 101, a storage unit 102, and a control unit 103. The server device 10 is, for example, one computer. Alternatively, the server device 10 may be composed of two or more computers that are connected such that information communication can be performed and operate in cooperation with each other. In that case, the arrangement shown in FIG. 1 is conveniently located on two or more computers.

The communication unit 101 includes one or more communication interfaces. The communication interface is, for example, a LAN interface. The communication unit 101 receives information used for the operation of the server device 10 and transmits information obtained by the operation of the server device 10. The server device 10 is connected to the network 11 by the communication unit 101 and performs information communication with the power supply vehicle 12 and the facility 13 via the network 11.

The storage unit 102 includes, for example, one or more semiconductor memories, one or more magnetic memories, one or more optical memories, or a combination of at least two of these that function as a main memory, an auxiliary memory, or a cache memory. A semiconductor memory is, for example, a Random Access Memory (RAM) or a Read Only Memory (ROM). The RAM is, for example, Static RAM (SRAM) or Dynamic RAM (DRAM). The ROM is, for example, an electrically erasable programmable ROM (EEPROM). The storage unit 102 stores information used for the operation of the control unit 103 and information obtained by the operation of the control unit 103.

The control unit 103 includes one or more processors, one or more dedicated circuits, or a combination thereof. The processor is, for example, a general-purpose processor such as a Central Processing Unit (CPU), or a dedicated processor such as a Graphics Processing Unit (GPU) that specializes in a particular process. A dedicated circuit is, for example, a Field-Programmable Gate Array (FPGA), an Application Specific Integrated Circuit (ASIC), or the like. The control unit 103 executes information processing related to the operation of the server device 10 while controlling each component of the server device 10.

The functions of the server device 10 are realized by executing the control program by the processor included in the control unit 103. The control program is a program for causing a computer to execute a step process included in the operation of the server device 10, thereby causing the computer to implement a function corresponding to the step process. That is, the control program is a program for causing the computer to function as the server device 10. Also, part or all of the functions of the server device 10 may be implemented by a dedicated circuit included in the control unit 103. Further, the control program may be stored in a non-transitory recording/storage medium that can be read by the server device 10, and the server device 10 may read the control program from the medium.

Next, a configuration example of the power supply vehicle 12 will be described. The power supply vehicle 12 has an in-vehicle device 14 and a battery 15. The in-vehicle device 14 has a communication unit 121, a storage unit 122, a control unit 123, a positioning unit 124, an input unit 125, an output unit 126, and a detection unit 127. One or more of these units may be configured as one control device, or may be configured by a personal computer including a tablet terminal, a smartphone terminal, or a navigation device. Or each part may be connected so that information communication is possible via the in-vehicle network based on standards, such as Controller Area Network (CAN). Each part of the in-vehicle device 14 is configured to be operable by the battery 15 even when the power supply vehicle 12 is parked and the accessory is turned off, for example. The battery 15 is, for example, a lithium ion battery.

The communication unit 121 includes one or more communication interfaces. The communication interface is, for example, an interface compatible with mobile communication standards such as a long term evolution (LTE), 4G, or 5G. The communication unit 121 receives information used for the operation of the control unit 123 and transmits information obtained by the operation of the control unit 123. The control unit 123 is connected to the network 11 via a mobile communication base station by the communication unit 121 and performs information communication with the server device 10 and the like via the network 11.

The storage unit 122 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 122 functions as, for example, a main memory device, an auxiliary memory device, or a cache memory. The storage unit 122 stores information used for the operation of the control unit 123 and information obtained by the operation of the in-vehicle device 14.

Control unit 123 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 123 executes information processing related to the operation of the power supply vehicle 12 while controlling each unit of the in-vehicle device 14.

The positioning unit 124 includes one or more Global Navigation Satellite System (GNSS) receivers. GNSS includes, for example, Global Positioning System (GPS), Quasi-Zenith Satellite System (QZSS), BeiDou, Global Navigation Satellite System (GLONASS), and/or Galileo. The positioning unit 124 acquires position information of the power supply vehicle 12.

The input unit 125 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. Input unit 125 accepts an operation to input information used for the operation of control unit 123 and sends the input information to control unit 123.

The output unit 126 includes one or more output interfaces. The output interface is, for example, a display or a speaker. The display is for example a Liquid Crystal Display (LCD) or an organic Electro-Luminescence (EL) display. The output unit 126 outputs information obtained by the operation of the control unit 123.

The detection unit 127 has an interface with one or more sensors that detect the state of each part of the power supply vehicle 12, or has one or more sensors. The sensor includes, for example, a sensor that detects the remaining battery capacity of the battery 15, a sensor that detects the motion state (speed, longitudinal acceleration, lateral acceleration, deceleration, etc.) of the power supply vehicle 12, and the like. The detection unit 127 sends information indicating each state detected by the sensor to the control unit 123.

Functions of the control unit 123 are realized by executing a control program by a processor included in the control unit 123. The control program is a program for causing a computer to execute a step process included in the operation of the control unit 123, thereby causing the computer to realize a function corresponding to the step process. That is, the control program is a program for causing the computer to function as the control unit 123. Also, part or all of the functions of the control unit 123 may be realized by a dedicated circuit included in the control unit 123.

Next, a configuration example of the facility 13 will be described. The facility 13 has a control device 16, a distributed power source 17 and a charging and discharging device 18. In the facility 13, the control device 16 supplies power obtained from the distributed power source 17 to power loads within the facility 13 and supplies the power to vehicles and the like by the charging and discharging device 18.

The control device 16 includes a power conditioner, and includes a communication unit 121, a storage unit 122, a control unit 123, a positioning unit 124, an input unit 125, an output unit 126, and a detection unit 127. One or more of these units may be configured as one control device, or may be configured by a personal computer including a tablet terminal, a smartphone terminal, or the like.

The communication unit 161 includes one or more communication interfaces. The communication interface is, for example, a LAN interface that can be connected to a home or premises LAN, or an interface compatible with mobile communication standards. Communication unit 161 receives information used for the operation of control unit 163 and transmits information obtained by the operation of control unit 163. The control unit 163 is connected to the network 11 by the communication unit 161 and performs information communication with other devices via the network 11.

The storage unit 162 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 162 functions as, for example, a main memory device, an auxiliary memory device, or a cache memory. Storage unit 162 stores information used for the operation of control unit 163 and information obtained by the operation of control unit 163.

Control unit 163 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 163 performs information processing related to the operation of the vehicle with a dead battery while controlling each unit of the control device 16.

The input unit 165 includes one or more input interfaces. The input interface is, for example, a physical key, a capacitive key, a pointing device, a touch screen integrated with a display, or a microphone that receives voice input. Input unit 165 accepts an operation to input information used for the operation of control unit 163 and sends the input information to control unit 163.

The output unit 166 includes one or more output interfaces. The output interface is, for example, a display or a speaker. The display is, for example, an LCD or an organic EL display. The output unit 166 outputs information obtained by the operation of the control unit 163.

The detection unit 167 has an interface with one or more sensors that detect the state of each part in the facility 13, or has one or more sensors. The sensor includes, for example, a sensor that detects the remaining amount of generated power or stored power obtained from the distributed power source 17, a sensor that detects the power that the charging and discharging device 18 supplies to the vehicle or the like, and the like. The detection unit 167 sends information indicating each state detected by the sensor to the control unit 163.

The distributed power source 17 includes a power generation device using alternative energy such as sunlight and wind power, a fuel cell, a storage battery, and the like, and control circuits thereof.

The charging and discharging device 18 is a charging and discharging station installed in the facility 13, and includes a charging and discharging station that can charge the battery 15 of the power supply vehicle 12 with power obtained from the distributed power source 17 when the power supply vehicle 12 is electrically connected thereto.

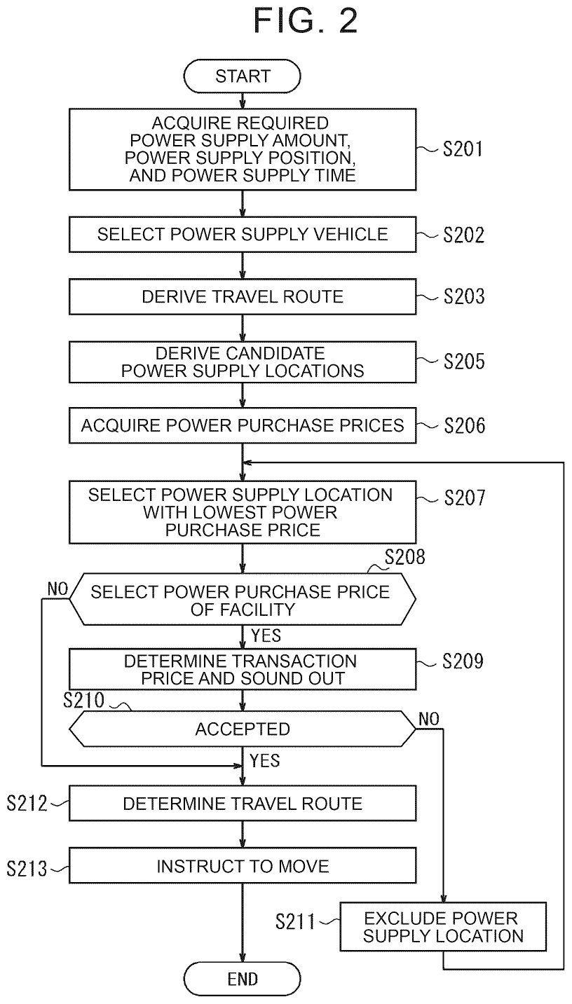

FIG. 2 is a flowchart illustrating the operation of the server device 10 related to instructing the power supply vehicle 12 to perform on-site charging. The procedure in FIG. 2 is executed by the control unit 103 of the server device 10. The procedure of FIG. 2 is executed when the server device 10 determines that on-site charging is necessary for the vehicle with a dead battery. For example, when the server device 10 receives a power supply request from another vehicle such as a BEV, HEV, or PHEV, or detects a vehicle with a dead battery based on the remaining battery capacity of each vehicle collected from other vehicles, the server device 10 determines the necessity of on-site charging. Whether the vehicle is out of battery is determined by each vehicle or the server device 10. For example, when the remaining battery capacity of the vehicle falls below an arbitrary State of Charge (SOC) value, the vehicle is determined to be out of battery.

In S201, the control unit 103 acquires the required power supply amount, the power supply position, and the power supply time. The control unit 103 sends information requesting such information to the vehicle with a dead battery, and acquires information sent from the vehicle with a dead battery in response to this request. When the control unit 103 determines that a plurality of vehicles is out of battery, the control unit 103 identifies one of these vehicles by an arbitrary algorithm. For example, the first vehicle determined to be out of battery is identified. The required power supply amount is the amount of power required for the vehicle with a dead battery to have an arbitrary reference remaining battery capacity, and is sent from the vehicle with a dead battery. The arbitrary reference remaining battery capacity is, for example, an arbitrary SOC value between 80% and 100%. The power supply position is the current position of the vehicle with a dead battery and is used as the destination of the power supply vehicle 12. The power supply time is the time at which power supply should be started. The power supply time is determined in the vehicle with a dead battery. The power supply time is, for example, an arbitrary required power supply time before the scheduled travel start time set for the vehicle with a dead battery, and is sent from the vehicle with a dead battery to the server device 10. Also, the power supply time may be specified by the occupant of the vehicle with a dead battery and sent to the server device 10.

In S202, the control unit 103 selects the power supply vehicle 12 to perform on-site charging. The control unit 103 acquires position information and remaining battery capacity information for each power supply vehicle 12 from the power supply vehicle 12. The control unit 103 sends a request for location information and remaining battery capacity information to one or more power supply vehicles 12 via the communication unit 101. In response to this, the in-vehicle device 14 of the power supply vehicle 12 sends the position information of the power supply vehicle 12 and the remaining capacity level information. These pieces of information are sent together with identification information for each power supply vehicle 12. The battery remaining amount information is, for example, the SOC value of the battery 15. Then, the control unit 103 selects the power supply vehicle 12 having the maximum remaining battery capacity within an arbitrary distance range from the power supply position. Such an arbitrary distance range is, for example, such a distance range within which the power supply position can be reached between the current time and the power supply time when moving at a legal speed.

In S203, the control unit 103 derives the travel route of the power supply vehicle 12. The travel route is, for example, a route that can reach the power supply position in the shortest distance or time from the current position of the power supply vehicle 12. The server device 10 uses map information to derive a travel route by an arbitrary algorithm.

In S205, the control unit 103 derives candidate power supply locations. The candidate power supply locations are, for example, facilities 13 or power supply stations within an arbitrary distance range from the travel route. The distance range is a distance range within which the power supply position can be reached by the power supply time even if the vehicle deviates from the travel route. The storage unit 102 stores the positions of one or more facilities 13 and the positions of power supply stations in association with the map information. Using this information, the control unit 103 derives candidate power supply locations.

In S206, the control unit 103 acquires information on the power purchase price. For example, when the candidate power supply location is the facility 13, the control unit 103 sends to a server of a power system in the district in which the facility 13 is included a request for information on the power selling price at which the facility 13 can sell power to the power system, namely the power purchase price at which the power supply vehicle 12 purchases power. When the candidate power supply location is a power supply station, a request is made to the server of the district containing the power supply station for the method of the power purchase price when receiving power supply. The control unit 103 receives information sent by each server in response to a request.

In S207, the control unit 103 selects the power supply location with the lowest power purchase price from the power supply location candidates.

If the power purchase price from one facility 13 is the lowest and that facility 13 is selected as the power supply location (Yes in S208), the control unit 103 determines the transaction price in S209 and asks the facility 13 about it. For example, the control unit 103 uses an arbitrary algorithm to set a transaction price that is equal to or higher than the power purchase price from the facility 13 and lower than the power purchase price of the lowest power supply station. For example, an average of the power purchase price of the facility 13 and the power purchase price of the power supply station is set as the transaction price. If the power purchase price fluctuates depending on the time of day, the control unit 103 may set the transaction price using the power purchase price of the time when the power supply vehicle 12 arrives at the facility 13. Then, the control unit 103 sends information to the control device 16 of the selected facility 13 to encourage power selling at the transaction price. This information may include the scheduled time at which the power supply vehicle 12 arrives and purchases power. Such information includes, for example, a character string to purchase power at the transaction price. In the facility 13, when such information is output by the control device 16, the user of the facility 13 inputs information indicating acceptance or rejection in response to this. The input information is then sent from the control device 16 to the server device 10.

When the power selling and purchasing at the transaction price is accepted (Yes in S210), the control unit 103 determines a changed travel route changed so as to pass the facility 13 in S212. On the other hand, when the power selling at the transaction price is not accepted (No in S210), the control unit 103 excludes the facility 13 from the candidate power supply locations in S211, returns to S207, and selects the facility 13 or the power supply station with the next lowest power purchase price as the power supply location, and S209 and S210 are repeated.

In S212, when the facility 13 is selected as the power supply location, the control unit 103 determines the travel route changed so as to pass through the facility 13. Alternatively, when the facility 13 is not selected as the power supply location (No in S208), the control unit 103 determines the travel route changed so as to pass through the power supply station closest to the travel route or having the lowest power purchase price.

In S213, the control unit 103 sends an instruction to move to the power supply vehicle 12. The control unit 103 sends to the selected power supply vehicle 12 the travel route determined in S212 and an instruction to move to the power supply location. The power supply vehicle 12 starts moving in response to this instruction, or outputs the contents of the instruction to the occupant and starts moving according to the operation of the occupant, and moves to the power supply position. The power supply vehicle 12 stops at a power supply location, that is, a facility 13 or a power supply station, at an intermediate position on the travel route, and receives power at the power selling price approved by the facility 13 or at the power purchase price that is the price when receiving power supply from the power supply station. In this way, it is possible to optimize the cost when the power supply vehicle 12 performs on-site charging. That is, it is possible to improve the charging efficiency of the power supply battery of the power supply vehicle.

In S209, when determining the transaction price, the control unit 103 may set a transaction price that is close to or matches the power purchase price from the facility 13 by arbitrary weighting. By doing so, it becomes possible to purchase electric power for the power supply vehicle 12 at a lower cost.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

What is claimed is:

1. A server device comprising:
a communication unit; and
a control unit configured to communicate with a vehicle via the communication unit, wherein the control unit is configured to acquire information on a first power purchase price from a charging point and a second power purchase price from a facility, and when the second power purchase price is lower than the first power purchase price, send to a power supply vehicle configured to supply power to another vehicle an instruction to move along a travel route that passes through the facility.

2. The server device according to claim 1, wherein the control unit is configured to send the instruction on a condition that the control unit receives, from the facility, information indicating consent to power purchase at a third power purchase price, the third power purchase price being equal to or higher than the second power purchase price and lower than the first power purchase price.

3. The server device according to claim 2, wherein the control unit is configured to determine the third power purchase price based on a time characteristic of the second power purchase price, and send information on the third power purchase price to the facility to encourage consent to the power purchase.

4. The server device according to claim 1, wherein the second power purchase price is a price at which the facility sells power to a power system.
